(19) United States
(12) Patent Application Publication
(10) Pub. No.: US 2012/0026309 A1
(43) Pub. Date: Feb. 2, 2012

(54) MEDIA DISPLAY SYSTEM AND ADJUSTMENT METHOD THEREFOR

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 12/871,943

(22) Filed: Aug. 31, 2010

(30) Foreign Application Priority Data
Jul. 30, 2010 (TW) 99125408

(51) Int. Cl. H04N 7/18; G06K 9/00

(52) U.S. Cl. 348/77; 382/103; 348/E07.085

(57) ABSTRACT

An adjustment method for a media display system includes a time-of-flight (TOF) camera capturing an image of a scene in front of an electronic billboard and obtaining data about distances between a number of points in the scene and the TOF camera. Building a three dimension (3D) model of the scene. Checking the 3D model to detect a face region in the 3D model. Detecting a reference eyeline in the 3D model. Obtaining a midline of the 3D model. Comparing the reference eyeline with the midline to determine whether the two lines overlap and outputting a comparison signal correspondingly, and driving a driving apparatus according to the comparison signal to adjust height of the electronic billboard.

### CROSS-REFERENCE TO RELATED APPLICATION

Relevant subject matter is disclosed in the co-pending U.S. patent application (Attorney Docket No. US32448) having the same title, which is assigned to the same assignee as named herein.

### BACKGROUND

1. Technical Field

The present disclosure relates to a media display system and an adjustment method for the media display system.

2. Description of Related Art

Outdoor media, such as electronic billboards, provide advertising and information to the public. Most of these electronic billboards are mounted at a fixed height. Viewing of the display may be uncomfortable or difficult for those viewers that must turn or angled their heads to properly read or view what is on the electronic billboard.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of an exemplary embodiment of a media display system with a driving apparatus.

FIG. 2 is similar to FIG. 1, but viewed from another perspective.

FIG. 3 is an explored, isometric view of the driving apparatus of FIG. 1.

FIG. 4 is a block diagram of the media display system of FIG. 1 with a storage unit.

FIG. 5 is a block diagram of the storage unit of FIG. 4.

FIGS. 6 and 7 are schematic views showing adjusting of the media display system of FIG. 1.

FIG. 8 is a flowchart of an exemplary embodiment of an adjustment method for a media display system.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

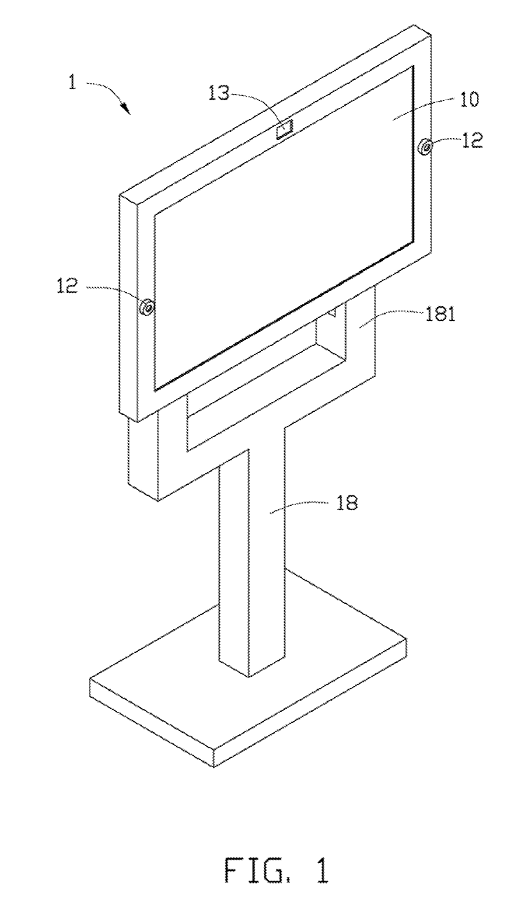

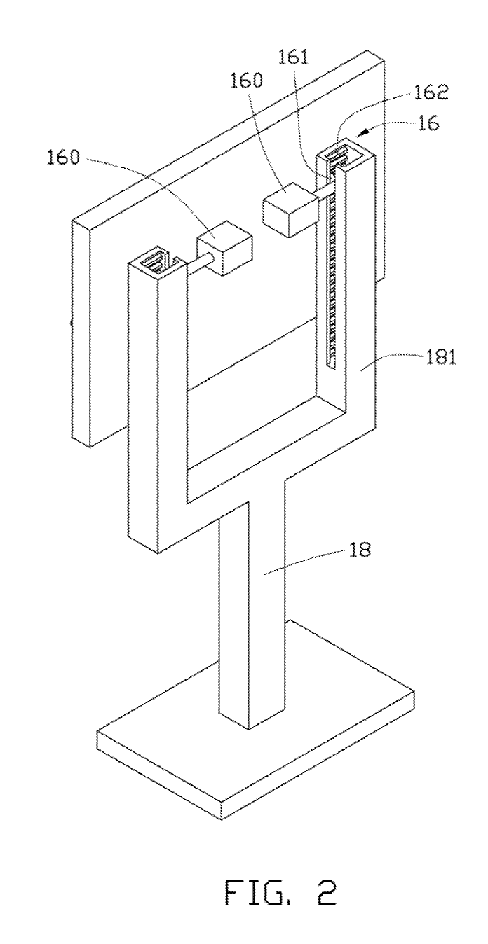

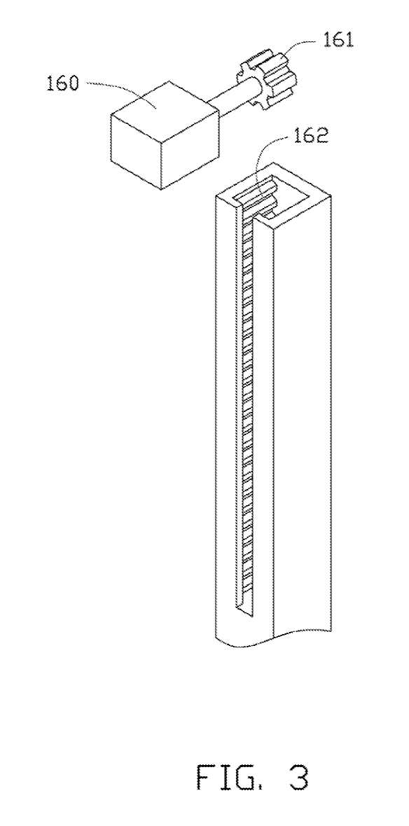

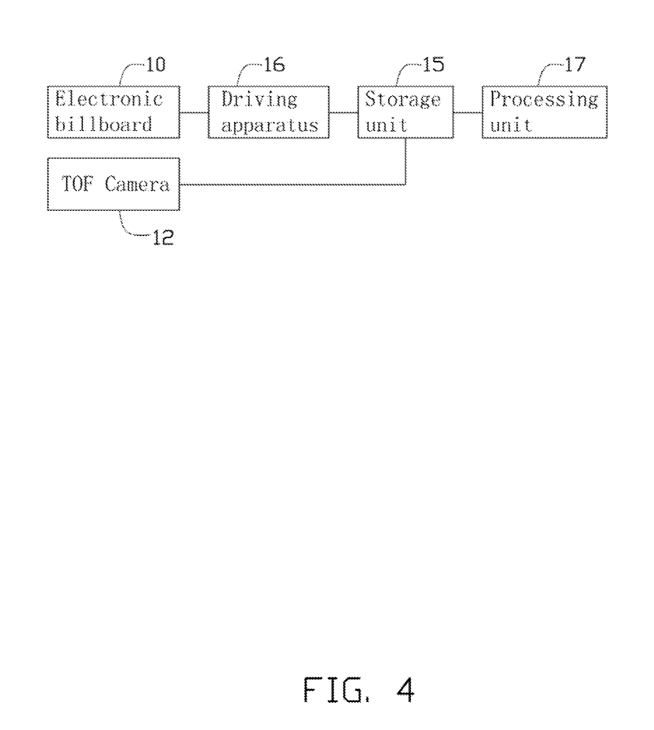

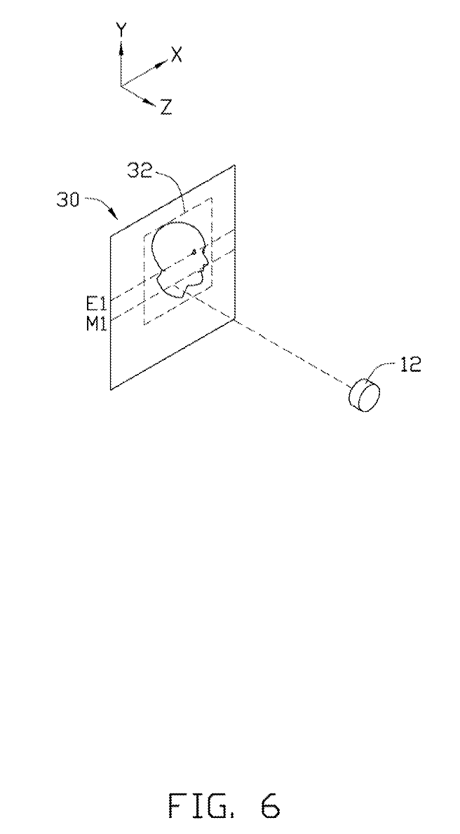

Referring to FIGS. 1 to 4, an exemplary embodiment of a media display system 1 includes an electronic billboard 10, two time-of-flight (TOF) cameras 12, a storage unit 15, a processing unit 17, a pair of driving apparatuses 16, and a stand 18. The media display system 1 can adjust a height of the electronic billboard 10. Referring to FIG. 6, in the embodiment, it is assumed that when a viewer's eyeline is aligned with a midline of the electronic billboard 10, viewability is optimized. In other embodiments, the relationship between the electronic billboard 10 and the viewer can be preset.

The TOF cameras 12 are mounted on a left side and a right side of the horizontally extended midline (the midline) of the electronic billboard 10, respectively, to capture images of a scene in front of the electronic billboard 10, and create data about distances between a plurality of points in the scene and the TOF cameras 12. The processing unit 17 and the storage unit 15 process the images and the data about distances obtained by the TOF cameras 12 to obtain a three dimension (3D) model of the scene in front of the electronic billboard 10, for determining a reference eyeline E1 in the 3D model and a midline M1 of the 3D model. The processing unit 17 and the storage unit 15 further control the driving apparatus 16 to adjust the height of the electronic billboard 10 to synchronize the reference eyeline E1 and the midline M1 of the 3D model. In other embodiments, there may be only one TOF camera 12 mounted on the left side or the right side of the midline of the electronic billboard 10.

Each TOF camera 12 is a camera system that creates data about distances between a plurality of points in front of the electronic billboard 10 and the TOF camera 12. When the TOF camera 12 shoots the scene in front of the electronic billboard 10, the TOF camera 12 sends radio frequency (RF) signals. The RF signals would return to the TOF camera 12 when the RF signals meet an object, such as a tree in the scene. As a result, the data about distances can be obtained according to time differences between sending and receiving the RF signals of the TOF camera 12.

In the embodiment, the stand 18 has a Y-shaped configuration and includes a pair of vertical arms 181. Each of the arms 181 defines a receiving space, and a vertical slot defined in a first sidewall of the arms 181 communicates with the receiving space. Each driving apparatus 16 includes a motor 160 attached to a rear of the billboard 10, a gear 161 attached to a rotor of the motor 160, and a track 162 formed on an inside of a second sidewall of the arm 181 perpendicular to the first sidewall. The gear 161 is received in the receiving space of the stand 18 to engage the track 162 and the rotor of the motor 160 extends through the slot of the stand 18. In addition, a motion sensor (such as, a G sensor) 13 is mounted to the electronic billboard 10 to determine whether the electronic billboard 10 moves when the driving apparatus 16 operates.

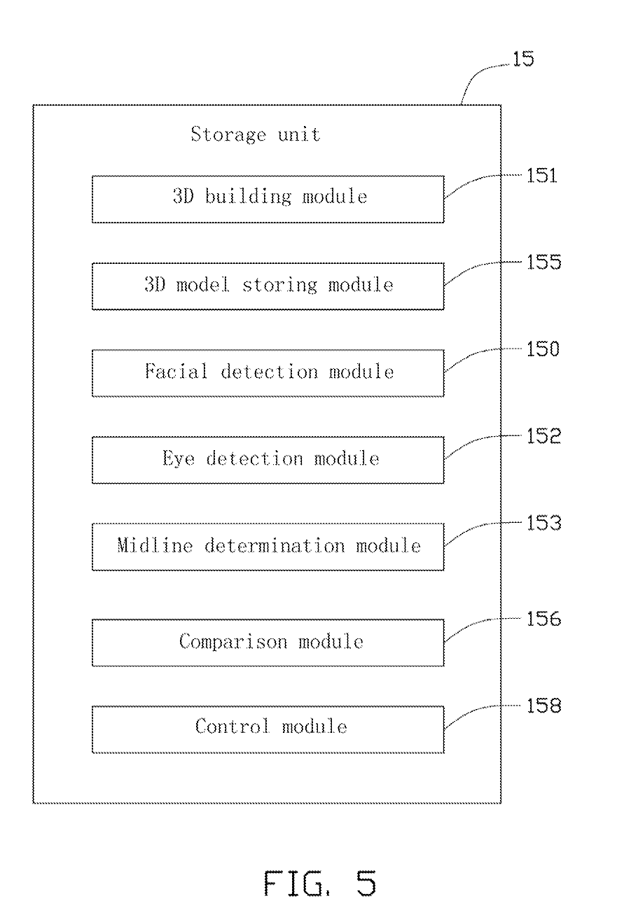

Referring to FIG. 5, the storage unit 15 includes a three dimension (3D) building module 151, a 3D model storing module 155, a facial detection module 150, an eye detection module 152, a midline determination module 153, a comparison module 156, and a control module 158. The 3D building module 151, the facial detection module 150, the eye detection module 152, the midline determination module 153, the comparison module 156 and the control module 158 may include one or more computerized instructions executed by the processing unit 17.

The 3D model building module 151 builds a 3D model of the scene in front of the electronic billboard 10 according to the image captured by the TOF camera 12 and the data about distances between the plurality of points in the scene and the TOF camera 12. In the embodiment, according to the data about distances between the plurality of points in the scene in front of the electronic billboard 10 and the TOF camera 12, the plurality of points in the scene has coordinates relative to the TOF camera 12. The 3D model building module 151 can obtain a 3D mathematical model according to the coordinates of the plurality of points and the image. The 3D mathematical model can be regarded as the 3D model of the scene in front of the electronic billboard 10.

The 3D model storing module 155 stores a plurality of different 3D models of human faces. The different 3D models of human faces can be obtained by the TOF camera 12 in advance.

The facial detection module 150 checks the 3D model of the scene in front of the electronic billboard 10 to find a face region in the 3D model of the scene. In the embodiment, the facial detection module 150 compares the different 3D models of human faces stored in the 3D model storing module 155 with the obtained 3D model of the scene in front of the electronic billboard 10 to find the face region in the 3D model of the scene.

The eye detection module 152 detects the reference eyeline E1 of the eye in the face region in the 3D model. The eye detection module 152 uses well known recognition technology to find an eye region in the face region. In other embodiment, a top one-third of the face region can be regarded as the reference eyeline E1.

The midline determination module 155 obtains the midline M1 of the 3D model of the scene on a Y-axis of a coordinate system. The comparison module 156 compares the midline M1 and the reference eyeline E1 of the face region in the 3D model of the scene, and outputs a corresponding comparison signal to the control module 158. The control module 158 directs the driving apparatus 16 to adjust the height of the electronic billboard 10.

Referring to FIG. 6, the TOF camera 12 captures an image of the scene in front of the electronic billboard 10 and obtains distance data. The 3D model building module 151 builds a 3D model 30 of the scene in front of the electronic billboard 10 according to the image captured by the TOF camera 12 and the distance data. In the embodiment, in the 3D model 30, other portions, such as the shoulder and neck, are cropped.

The facial detection module 150 checks the face region 32 in the 3D model 30. The eye detection module 152 calculates the reference eyeline E1 in the face region 32. The midline determination module 155 obtains the midline M1 of the 3D model 30 on the Y-axis of the coordinate system. The comparison module 156 compares the midline M1 of the 3D model 30 on the Y-axis of the coordinate system with the reference eyeline E1 in the face region 32 to determine that the reference eyeline E1 of the face region 32 is misaligned with the midline M1 of the 3D model 30, and outputs a corresponding comparison signal to the control module 158.

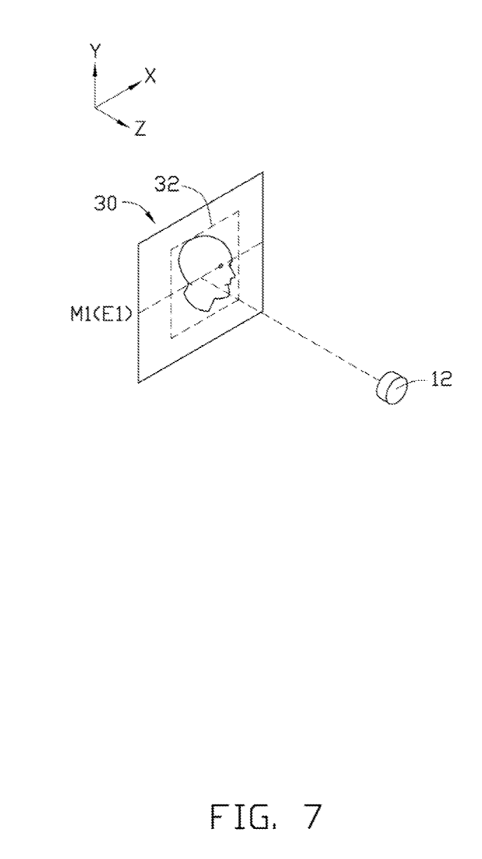

The control module 158 directs the driving apparatus 16 to move the electronic billboard 10 up a distance, such as two centimeters. Conversely, if the reference eyeline E1 of the face region 32 in the 3D model 30 is lower than the midline M1 of the 3D model 30, the control module 158 directs the driving apparatus 16 to move the electronic billboard 10 down a distance, such as one centimeter. Repeating these actions, referring to FIG. 7, to overlap the midline M1 of the 3D model 30 on the Y-axis of the coordinate system with the reference eyeline E1. Then, the control module 158 stops the driving apparatus 16

When the TOF camera 12 is mounted on the midline of the electronic billboard 10, the midline of the electronic board 10 is in alignment with the midline M1 of the 3D model 30 on the Y-axis of the coordinate system. Referring to FIG. 7, when the reference eyeline E1 of the face region 32 is in alignment with the midline M1 of the 3D model 30 on the Y-axis of the coordinate system, the viewer can comfortably view the electronic billboard 10.

In the embodiment described above, there is only one viewer. In other embodiments, if there is more than one viewer, the facial detection module 150 checks the 3D model to locate a plurality of face regions in the 3D model. The eye detection module 152 checks the face regions to locate a reference eyeline in each face region, and obtains an average location of the plurality of eye regions. The comparison module 156 compares the average reference eyeline of the eye regions with the midline M1 of the 3D model 30 on the Y-axis of the coordinate system.

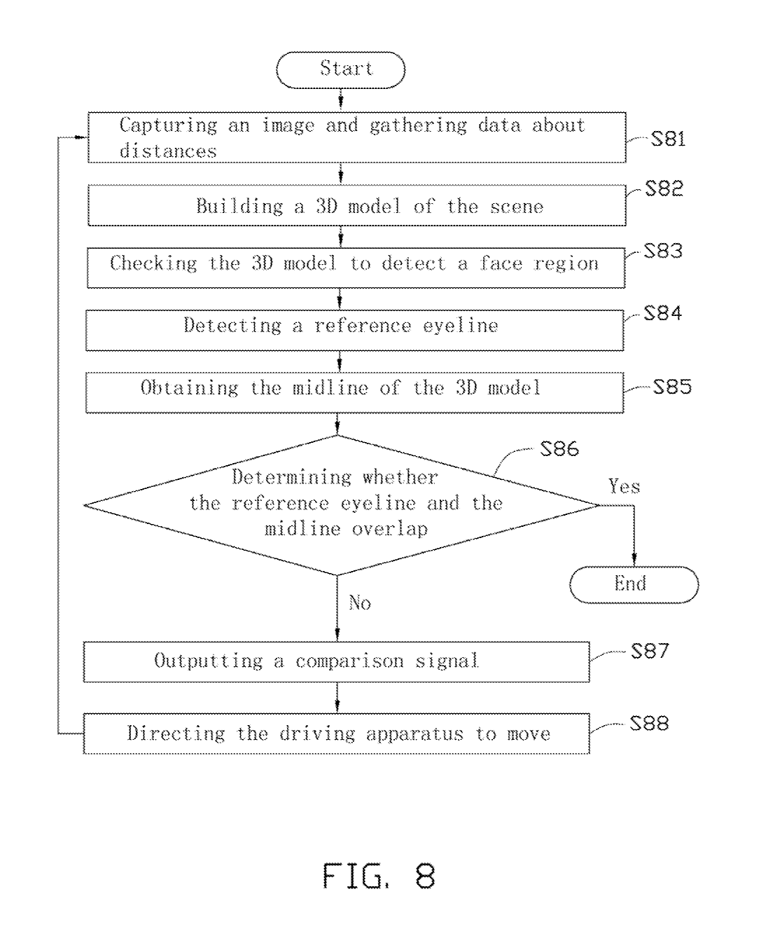

FIG. 8 shows an adjustment method for an electronic billboard 10 as follows.

In step S81, the TOF camera 12 captures an image of a scene in front of the electronic billboard 10. The TOF camera 12 further gathers data about distances between a plurality of points in the scene and the TOF camera 12.

In step S82, the 3D model building module 155 builds a 3D model 30 of the scene in front of the electronic billboard 10 according to the image captured by the TOF camera 12 and the data about distances between the plurality of points in the scene and the TOF camera 12.

In step S83, the facial detection module 150 checks the 3D model 30 to find a face region 32 in the 3D model 30.

In step S84, the eye detection module 152 detects a reference eyeline in the face region 32.

In step S85, the midline determination module 153 obtains the midline M1 of the 3D model 30 on the Y-axis of the coordinate system.

In step S86, the comparison module 156 compares the reference eyeline E1 with the midline M1 of the 3D model 30 to determine whether the reference eyeline E1 and the midline M1 overlap. Once the reference eyeline E1 and the midline M1 overlap, the viewer can comfortably view the contents on the electronic billboard 10. If the reference eyeline E1 and the midline M1 are not overlapped, step S87 is implemented.

In step S87, the comparison module 156 outputs a comparison signal according to the comparison of the midline M1 and the reference eyeline E1 of the face region in the 3D model of the scene.

In step S88, the control module 158 directs the driving apparatus 16 to move according to the comparison signal, and step S81 is repeated.

The foregoing description of the embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A media display system comprising:
an electronic billboard attached to a stand;
a time-of-flight (TOF) camera mounted on a midline of the electronic billboard, to capture an image of a scene in front of the electronic billboard and obtain data about distances between a plurality of points in the scene and the TOF camera;
a driving apparatus to adjust a position of the electronic billboard relative to the stand for changing a height of the electronic billboard;
a processing unit; and
a storage unit connected to the processing unit, the TOF camera, and the driving apparatus, and storing a plurality of programs to be executed by the processing unit, wherein the storage unit comprises:
a three dimension (3D) building module to build a 3D model of the scene according to the image of the scene and the data about distances between the plurality of points in the scene and the TOF camera;
a facial detecting module to check the 3D model to detect a face region in the 3D model;
an eye detection module to detect a reference eyeline of eyes in the face region of the 3D model;
a midline determination module to obtain a midline of the 3D model;
a comparison module to compare a reference eyeline of the face region with the midline of the 3D model to determine whether the reference eyeline of the eye region and the midline of the 3D model overlap, and output a comparison signal correspondingly; and
a control module to control the driving apparatus to move the billboard according to the comparison signal.

2. The media display system of claim 1, wherein a top one-third of the face region is regarded as the reference eyeline.

3. The media display system of claim 1, wherein the storage unit further comprises a 3D model storing module, the 3D model storing module stores a plurality of different 3D models of human faces, the facial detection module compares the different 3D models of human faces stored in the 3D model storing module with the 3D model of the scene in front of the electronic billboard to detect the face region.

4. The media display system of claim 1, wherein the driving apparatus comprises a motor attached to the rear side of the billboard, a gear attached to a rotor of the motor, and a track vertically formed in the stand, wherein the gear meshes with the track to adjust a height of the electronic billboard.

5. An adjustment method for a media display system, the adjustment method comprising:
capturing an image of a scene in front of an electronic billboard by a time-of-flight (TOF) camera, and obtaining data about distances between a plurality of points in the scene and the TOF camera;
building a three dimension (3D) model of the scene according to the image and the data about distances between the plurality of points in the scene and the TOF camera;
checking the 3D model to detect a face region in the 3D model;
obtaining a reference eyeline in the face region;
obtaining a midline of the 3D model;
comparing the reference eyeline with the midline of the 3D model to determine whether the reference eyeline and the midline overlap, and output a comparison signal correspondingly; and
directing a driving apparatus to move an electronic billboard of the media display system according to the comparison signal to adjust a height of the electronic billboard.

6. The adjustment method of claim 5, wherein a top one-third of the face region in the 3D model is regarded as the reference eyeline.

7. The adjustment method of claim 5, wherein the step of “checking the 3D model to detect a face region in the 3D model” comprises:
comparing the 3D model of the scene with a plurality of different 3D models of human faces to detect the face region in the 3D model.

8. The adjustment method of claim 5, wherein the driving apparatus comprises a motor attached to the rear side of the billboard, a gear attached to a rotor of the motor, and a track vertically formed in the stand, wherein the gear meshes with the track to adjust a height of the electronic billboard.
